(19) United States
(12) Patent Application Publication
(10) Pub. No.: US 2023/0056825 A1
(43) Pub. Date: Feb. 23, 2023

(54) TONER

(71) Applicant: KYOCERA Document Solutions Inc., Osaka (JP)

(72) Inventor: Masanori SUGAHARA, Osaka-shi (JP)

(73) Assignee: KYOCERA Document Solutions Inc., Osaka (JP)

(21) Appl. No.: 17/817,266

(22) Filed: Aug. 3, 2022

(30) Foreign Application Priority Data
Aug. 4, 2021 (JP) 2021-128067

(51) Int. Cl. G03G 9/097; G03G 9/08

(52) U.S. Cl. CPC G03G 9/09708; G03G 9/0823; G03G 9/0819; G03G 9/09766; G03G 9/09725

(57) ABSTRACT

A toner includes toner particles. The toner particles each include a toner mother particle and an external additive attached to the surface of the toner mother particle. The external additive includes first external additive particles and fluorine-containing particles. The first external additive particles each include an aluminum oxide particle, a conductive layer covering the aluminum oxide particle, and a single-layer or multilayer protective layer covering the conductive layer. The conductive layer contains antimony tin oxide. The protective layer includes a layer containing a component derived from a titanate coupling agent, or includes an inner layer containing methylol melamine, urethane resin, or aluminum hydroxide and an outer layer containing a component derived from a silane coupling agent. The first external additive particles have a powder specific resistance of no greater than 50 Ω·cm.

### INCORPORATION BY REFERENCE

The present application claims priority under 35 U.S.C. § 119 to Japanese Patent Application No. 2021-128067, filed on Aug. 4, 2021. The contents of this application are incorporated herein by reference in their entirety.

### BACKGROUND

The present disclosure relates to a toner.

Electrophotographic image formation uses a non-magnetic one-component developer, for example. The non-magnetic one-component developer includes a toner including toner particles. The toner is required to be excellent in charge stability and performance (image density stability) to continue formation of images with a desired image density in a stable manner. In electrophotographic image formation, an image defect called filming may occur due to a toner component attaching to the surface of a photosensitive drum. Therefore, the toner is required to be excellent in performance (filming resistance) to inhibit occurrence of filming.

For example, a toner including fluororesin particles is studied as a toner excellent in image density stability and charge stability. The fluororesin particles have surfaces with low adhesiveness. Therefore, the toner including the fluororesin particles tends to be excellent in fluidity and charge stability. As an example of the toner including the fluororesin particles, a toner is proposed that includes monodisperse spherical silica particles, toner particles containing a binder resin and a colorant, and polytetrafluoroethylene particles attached to the surfaces of the toner particles.

### SUMMARY

A toner according to an aspect of the present disclosure includes toner particles. The toner particles each include a toner mother particle and an external additive attached to a surface of the toner mother particle. The external additive includes first external additive particles and fluorine-containing particles. The first external additive particles each include an aluminum oxide particle, a conductive layer covering the aluminum oxide particle, and a single-layer or multilayer protective layer covering the conductive layer. The conductive layer contains antimony tin oxide. The protective layer includes a layer containing a component derived from a titanate coupling agent, or includes an inner layer containing methylol melamine, urethane resin, or aluminum hydroxide and an outer layer containing a component derived from a silane coupling agent. The first external additive particles have a powder specific resistance of no greater than 50 Ω·cm. The first external additive particles preferably have a number average primary particle diameter of at least 60 nm and no greater than 600 nm.

### BRIEF DESCRIPTION OF THE DRAWINGS

FIG. 1 is a diagram illustrating an example of a toner particle included in a toner according to the present disclosure.

FIG. 2 is a diagram illustrating an example of a first external additive particle.

FIG. 3 is a diagram illustrating another example of the first external additive particle.

FIG. 4 is a diagram illustrating an example of a fluorine-containing particle.

FIG. 5 is a diagram illustrating another example of the fluorine-containing particle.

FIG. 6 is a diagram illustrating an evaluation image formed in evaluation of toner collectability in Examples.

### DETAILED DESCRIPTION

The following describes an embodiment of the present disclosure. Note that a toner is a collection (e.g., a powder) of toner particles. An external additive is a collection (e.g., a powder) of external additive particles. Unless otherwise stated, evaluation results (specific examples include values indicating shape or physical properties) for a powder (specific examples include a powder of toner particles and a powder of external additive particles) are number averages of values measured for a suitable number of particles selected from the powder.

Values for volume median diameter (D₅₀) of a powder are values as measured based on the Coulter principle (electrical sensing zone technique) using “COULTER COUNTER MULTISIZER 3” produced by Beckman Coulter, Inc. unless otherwise stated.

Unless otherwise stated, the number average particle diameter of a powder is a number average value of equivalent circle diameters (Heywood diameters: diameters of circles having the same areas as projected areas of the primary particles) of primary particles of the powder as measured using a scanning electron microscope. The number average primary particle diameter of a powder is a number average value of equivalent circle diameters of 100 primary particles of the powder, for example. Note that the number average primary particle diameter of particles indicates a number average primary particle diameter of the particles of a powder unless otherwise stated.

Chargeability means chargeability in triboelectric charging unless otherwise stated. Positive chargeability (or negative chargeability) in triboelectric charging can be determined using a known triboelectric series. For example, a toner is mixed and stirred with a standard carrier (standard carrier for use with negatively chargeable toner: N-01, standard carrier for use with positively chargeable toner: P-01) provided by The Imaging Society of Japan to triboelectrically charge a measurement target. The charge amount of the measurement target is measured using for example a charge measurement device (Q/m meter) before and after triboelectric charging. A larger change in charge amount between before and after triboelectric charging indicates stronger chargeability of the measurement target.

The “main component” of a material means a component most abundant in the material in terms of mass unless otherwise stated.

Hydrophobicity (or hydrophilicity) can be expressed by a contact angle of a water droplet (ease of getting wet with water), for example. A lager contact angle of a water droplet indicates stronger hydrophobicity.

In the following description, the term “-based” may be appended to the name of a chemical compound to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof.

<Toner>

A toner according to an embodiment of the present disclosure includes toner particles. The toner particles each include a toner mother particle and an external additive attached to the surface of the toner mother particle. The external additive includes first external additive particles and fluorine-containing particles. The first external additive particles each include an aluminum oxide particle, a conductive layer covering the aluminum oxide particle, and a single-layer or multilayer protective layer covering the conductive layer. The conductive layer contains antimony tin oxide. The protective layer includes a layer containing a component derived from a titanate coupling agent, or includes an inner layer containing methylol melamine, urethane resin, or aluminum hydroxide and an outer layer containing a component derived from a silane coupling agent. The first external additive particles have a powder specific resistance of no greater than 50 Ω·cm. The first external additive particles have a number average primary particle diameter of at least 60 nm and no greater than 600 nm.

The toner of the present disclosure can be favorably used for electrostatic latent image development as a positively chargeable toner, for example. The toner may be used as a one-component developer. When used as a one-component developer, the toner is positively charged for example by friction with a developer bearing member or a toner charging member in a development device. An example of the toner charging member is a developer regulating blade. Details of the toner will be described below with reference to drawings as appropriate.

The toner of the present disclosure having the above features is excellent in image density stability, charge stability, and filming resistance. The reasons therefor will be described below. The toner of the present disclosure includes as an external additive fluorine-containing particles, which are particles having surfaces with low adhesiveness, and therefore is excellent in fluidity. As such, the toner of the present disclosure can be charged stably in a development device. However, a toner including fluorine-containing particles may exhibit an excessively large potential difference from the developer bearing member or the toner charging member in consecutive printing. In detail, when consecutive printing is performed using a toner including fluorine-containing particles, a portion of the fluorine-containing particles separates from the toner and attaches to the developer bearing member and the toner charging member in the development device. Due to the fluorine-containing particles being negatively chargeable, the developer bearing member and the toner charging member to which the fluorine-containing particles are attached are negatively charged. As a result, the potential difference between the toner and the developer bearing member or the toner charging member increases excessively. Therefore, the amount of toner transported by the developer bearing member gradually increases in consecutive printing to gradually increase image density of formed images.

By contrast, the toner of the present disclosure includes the first external additive particles as an external additive in addition to the fluorine-containing particles. The first external additive particles each include a conductive layer containing antimony tin oxide (ATO) to exhibit excellent conductivity (powder specific resistance of no greater than 50 Ω·cm). As a result of the toner of the present disclosure including the first external additive particles, excessive increase in potential difference between the toner and the developer bearing member or the toner charging member can be suppressed even in a situation in which the developer bearing member and the toner charging member are negatively charged. Thus, image density of images formed with the toner of the present disclosure can be unvarying even in consecutive printing. Furthermore, the protective layers of the first external additive particles have high hydrophobicity and are excellent in strength. This can allow the first external additive particles to exhibit the above effects for a long period of term. Consequently, the toner of the present disclosure has excellent image density stability. Furthermore, the aluminum oxide particles have relatively high hardness to exhibit excellent polishing action. As a result of the toner of the present disclosure including the first external additive particles that each include an aluminum oxide particle as a base, efficient cleaning of the surface of a photosensitive drum can be achieved. As such, as a result of a toner component attached to the surface of the photosensitive drum being cleaned, the toner of the present disclosure is excellent in filming resistance. Moreover, as a result of the first external additive particles having an appropriate number average primary particle diameter, the above effects can be stably exhibited.

The toner of the present disclosure will be described further in detail below. Note that for each component indicated below, one type of the component may be used independently or two or more types of the component may be used in combination.

[Toner Particles]

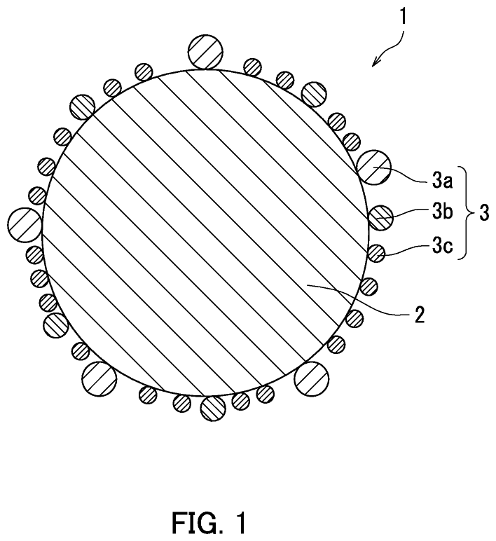

FIG. 1 illustrates an example of a toner particle 1 included in the toner. The toner particle 1 illustrated in FIG. 1 includes a toner mother particle 2 and an external additive 3 attached to the surface of the toner mother particle 2. The external additive 3 includes first external additive particles 3a, fluorine-containing particles 3b, and silica particles 3c.

However, the toner particles included in the toner of the present disclosure may each have a structure different from that of the toner particle 1 illustrated in FIG. 1. Specifically, the toner particles each need only include at least the first external additive particles and the fluorine-containing particles as the external additive. The toner particles may each further include, as an external additive, external additive particles (also referred to below as additional external additive particles) in addition to the first external additive particles, the fluorine-containing particles, and the silica particles. The toner particles may be toner particles (also referred to below as capsule toner particles) each including a shell layer. In the capsule toner particles, the toner mother particles each include a toner core containing a binder resin and a shell layer covering the surface of the toner core, for example. Details of the toner particles included in the toner of the present disclosure have been described so far with reference to FIG. 1.

[First External Additive Particles]

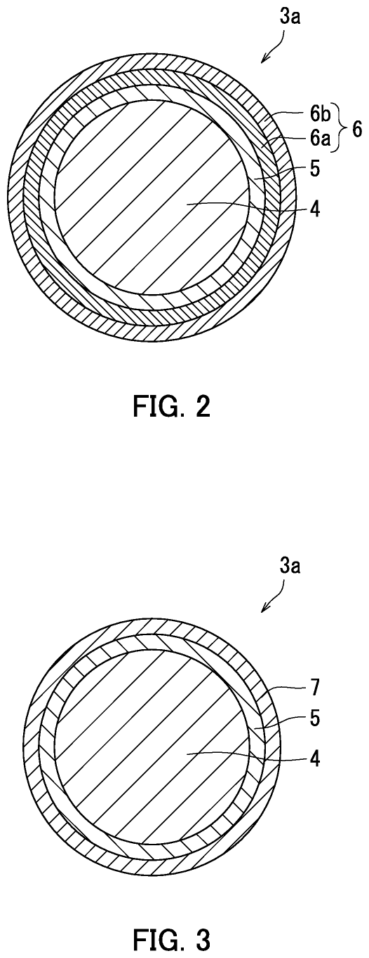

FIG. 2 illustrates an example of a first external additive particle 3a. The first external additive particle 3a illustrated in FIG. 2 includes an aluminum oxide particle 4, a conductive layer 5 covering the aluminum oxide particle 4, and a multilayer protective layer 6 covering the conductive layer 5. The multilayer protective layer 6 includes an inner layer 6a directly covering the conductive layer 5 and an outer layer 6b covering the inner layer 6a.

FIG. 3 illustrates another example of the first external additive particle 3a. A first external additive particle 3a illustrated in FIG. 3 includes an aluminum oxide particle 4, a conductive layer 5 covering the aluminum oxide particle 4, and a single-layer protective layer 7 covering the conductive layer 5. The first external additive particle 3a illustrated in FIG. 3 differs from the first external additive particle 3a illustrated in FIG. 2 in inclusion of the single-layer protective layer 7 rather than the multilayer protective layer 6.

Examples of the first external additive particles have been described so far with reference to FIGS. 2 and 3. However, the configuration of the first external additive particles is not limited to those illustrated in FIGS. 2 and 3. Specifically, the first external additive particles may each include another layer in addition to the conductive layer and the protective layer. Furthermore, the conductive layer is preferably a single layer but may be a multilayer. Preferably, the protective layer is a single layer or includes two layers, but may include a three or more layers. The first external additive particles will be described further in detail below.

The first external additive particles have a powder specific resistance of no greater than 50 Ω·cm, and preferably no greater than 30 Ω·cm. As a result of the powder specific resistance of the first external additive particles being set to no greater than 50 Ω·cm, the toner of the present disclosure can be excellent in image density stability. The powder specific resistance of the first external additive particles is measured by the method described in Examples or a method conforming the method.

The first external additive particles have a number average primary particle diameter of preferably at least 60 nm and no greater than 600 nm, and more preferably at least 150 nm and no greater than 250 nm. As a result of the number average primary particle diameter of the first external additive particles being set to at least 60 nm, the first external additive particles can be inhibited from being buried in the toner mother particles. As a result of the number average primary particle diameter of the first external additive particles being set to no greater than 600 nm, the first external additive particles can be inhibited from separating from the toner mother particles.

In terms of sufficiently exhibiting the function of the first external additive particles while inhibiting separation thereof from the toner mother particles, the amount of the first external additive particles in the toner particles is preferably at least 0.1 parts by mass and no greater than 5.0 parts by mass relative to 100 parts by mass of the toner mother particles, and more preferably at least 0.3 parts by mass and no greater than 2.0 parts by mass.

(Aluminum Oxide Particles)

The aluminum oxide particles are bases of the first external additive particles. The aluminum oxide particles contain aluminum oxide (specifically, Al₂O₃). The percentage content of the aluminum oxide in the aluminum oxide particles is preferably at least 80% by mass, more preferably at least 95% by mass, and further preferably 100% by mass.

The aluminum oxide particles can be obtained by pulverizing baked aluminum hydroxide using a pulverizer, for example.

(Conductive Layers)

The conductive layers contain antimony tin oxide (ATO). The percentage content of the ATO in the conductive layers is preferably at least 80% by mass, more preferably at least 95% by mass, and further preferably 100% by mass.

The following describes a method for covering the aluminum oxide particles with the conductive layers containing antimony tin oxide. First, the aluminum oxide particles are dispersed in a water-based solvent (e.g., water). Next, an alkaline aqueous solution (e.g., an ammonia aqueous solution) and an acid aqueous solution obtained by dissolving stannic chloride (SnCl₄) and antimony trichloride (SbCl₃) in hydrochloric acid are added to a suspension including the aluminum oxide particles. In the manner described above, coat layers are formed on the surfaces of the aluminum oxide particles. Thereafter, the aluminum oxide particles with the coat layers formed thereon are baked (e.g., heating temperature of at least 600° C. and no greater than 800° C., heating time of at least 1 hour and no greater than 4 hours), thereby obtaining aluminum oxide particles covered with the conductive layers containing antimony tin oxide. In addition of the acid aqueous solution and the alkaline aqueous solution, the pH and the temperature of the suspension should keep within respective certain ranges (e.g., pH of at least 6.5 and no greater than 9.0 and a temperature of at least 60° C. and no greater than 80° C.).

(Protective Layers)

The protective layers inhibit the conductive layers from peeling off. The protective layers have a single-layer structure or a multilayer structure (e.g., a two-layer structure). Specifically, the protective layers each include a layer containing a component derived from a titanate coupling agent, or each include an inner layer containing methylol melamine, urethane resin, or aluminum hydroxide and an outer layer containing a component derived from a silane coupling agent. The protective layer with any of the above layer structures can have high hydrophobicity and increased strength. In detail, layers containing a component derived from a titanate coupling agent have high hydrophobicity and are excellent in strength. Therefore, the protective layers alone can exhibit a function as the protective layers. The inner layers containing methylol melamine, urethane resin, or aluminum hydroxide are excellent in strength. The outer layers containing a component derived from a silane coupling agent have high hydrophobicity. Therefore, a combination of the inner layers and the outer layers described above can exhibit a function as the protective layers.

The protective layers may each further include an additional layer in addition to the above described layers. An example of the additional layer is a layer containing silicone oil. The layer containing silicone oil has high hydrophobicity likewise the outer layer containing a component derived from a silane coupling agent, and therefore is suitable as the outer layer.

(Titanate Coupling Agent)

Examples of the titanate coupling agent include isopropyltriisostearoyl titanate, isopropyltris(dioctylpyrophosphate)titanate, isopropyltri(N-aminoethyl-aminoethyl)titanate, tetraoctylbis(ditridecylphosphite)titanate, isopropyl trioctanoyl titanate, isopropyldimethacryl isostearoyl titanate, isopropyltridodecylbenzene sulfonyl titanate, isopropylisostearoyl diacrylic titanate, and isopropyltri(dioctylphosphate)titanate. The titanate coupling agent is preferably isopropyltriisostearoyl titanate.

(Silane Coupling Agent)

An example of the silane coupling agent is alkylalkoxysilane. An alkyl group of the alkylalkoxysilane is preferably an alkyl group with a carbon number of at least 3 and no greater than 8.

Examples of the alkylalkoxysilane include propyltrimethoxysilanes (specific examples include n-propyltrimethoxysilane and isopropyltrimethoxysilane), propyltriethoxysilanes (specific examples include n-propyltriethoxysilane and isopropyltriethoxysilane), butyltrimethoxysilanes (specific examples include n-butyltrimethoxysilane and isobutyltrimethoxysilane), butyltriethoxysilanes (specific examples include n-butyltriethoxysilane and isobutyltriethoxysilane), hexyltrimethoxysilanes (specific examples include n-hexyltrimethoxysilane), hexyltriethoxysilanes (specific examples include n-hexyltriethoxysilane), octyltrimethoxy silanes (specific examples include n-octyltrimethoxysilane), and octyltriethoxysilanes (specific examples include n-octyltriethoxysilane).

The silane coupling agent is preferably alkylalkoxysilane, more preferably monoalkyltrialkoxysilane, and further preferably isobutyltriethoxysilane.

(Silicone Oil)

Examples of the silicone oil include straight silicone oils (specific examples include dimethyl silicone oil, methylphenyl silicone oil, and methylhydrogen silicone oil), reactive modified silicone oils (specific examples include amino-modified silicone oil, epoxy-modified silicone oil, carboxyl-modified silicone oil, mercapto-modified silicone oil, methacrylic acid-modified silicone oil, phenol-modified silicone oil, and alcohol-modified silicone oil), and non-reactive modified silicone oils (specific examples include alkyl-modified silicone oil, higher fatty acid-modified silicon oil, fluorine-modified silicone oil, polyether-modified silicone oil, and methylstyryl-modified silicone oil). The silicone oil is preferably a straight silicone oil, and more preferably methylhydrogen silicone oil.

Examples of a protective layer formation method include: a method in which a raw material component of the protective layers is dripped into or sprayed toward a solution including the aluminum oxide particles covered with the conductive layers under stirring, and heating is performed then; and a method in which the aluminum oxide particles covered with the conductive layers are added to a solution of the raw material component of the protective layers under stirring and heating is performed then.

Examples of the raw material of the protective layers include a titanate coupling agent, melamine resin, urethane resin, a silane coupling agent, silicone oil, and a combination of polyaluminum chloride and a basic solution (e.g., an aqueous sodium hydroxide solution). Note that in a case in which the combination of polyaluminum chloride and a basic solution is used as the raw material of the protective layers, protective layers containing aluminum hydroxide are formed.

Preferably, the protective layers of the first external additive particles each have any of the following layer structures (A) to (C).

(A) Single-layer structure including a layer containing a component derived from a titanate coupling agent

(B) Two-layer structure including an inner layer containing a component derived from a titanate coupling agent and an outer layer containing silicone oil or a component derived from a silane coupling agent

(C) Two-layer structure including an inner layer containing methylol melamine, urethane resin, or aluminum hydroxide and an outer layer containing a component derived from a silane coupling agent

The first external additive particles can be prepared by sequentially covering the aluminum oxide particles with the conductive layers and the protective layers according to the above-described method.

[Fluorine-Containing Particles]

Fluorine-containing particles are particles containing a fluorine component. Examples of the fluorine component include fluororesin, a component derived from a fluorine-containing silane coupling agent, and fluorine-modified silicone oil.

The fluorine-containing particles are preferably fluororesin particles or second external additive particles. The second external additive particles each include a base and a fluorine component layer covering the base. The fluorine component layer contains fluorine-modified silicone oil or a component derived from a fluorine-containing silane coupling agent.

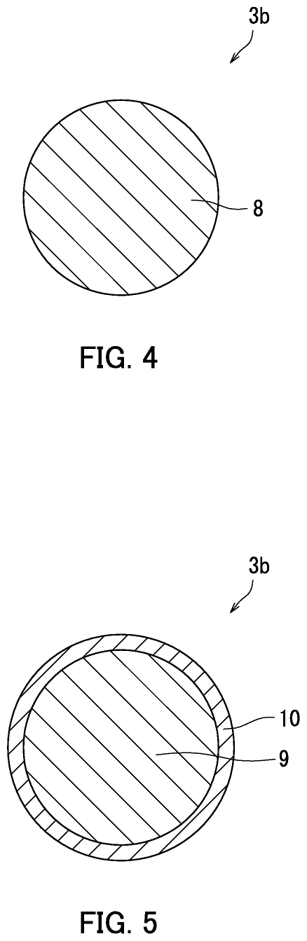

FIG. 4 illustrates an example of a fluorine-containing particle 3b. The fluorine-containing particle 3b illustrated in FIG. 4 is a fluororesin particle 8. FIG. 5 illustrates another example of the fluorine-containing particle 3b other than that in FIG. 4. The fluorine-containing particle 3b illustrated in FIG. 5 is a second external additive particle including a base 9 and a fluorine component layer 10 covering the base 9.

Examples of the fluorine-containing particles have been described so far with reference to the drawings. However, the structure of the fluorine-containing particles is not limited to those illustrated in FIGS. 4 and 5. Specifically, the second external additive particles may each further include a layer other than the fluorine component layer. Furthermore, the fluorine component layer is preferably a single layer but may include multiple layers. The fluorine-containing particles will be described further in detail below.

(Fluororesin Particles)

The fluororesin particles contain fluororesin. The percentage content of the fluororesin in the fluororesin particles is preferably at least 80% by mass, more preferably at least 95% by mass, and further preferably 100% by mass.

Examples of the fluororesin include polytetrafluoroethylene (PTFE), perfluoroalkoxy fluororesin, polychlorotrifluoroethylene, polyvinylidene fluoride, polydichlorodifluoroethylene, tetrafluoroethylene n-perfluoroalkyl vinyl ether copolymers, tetrafluoroethylene-hexafluoropropylene copolymers, tetrafluoroethylene-ethylene copolymers, tetrafluoroethylene-hexafluoropropylene-perfluoroalkylvinyl ether copolymers, and tetrafluoroethylene-perfluoroalkoxy ethylene copolymers. The fluororesin is preferably polytetrafluoroethylene or perfluoroalkoxy fluororesin.

(Second External Additive Particles)

The second external additive particles each include a base and a fluorine component layer covering the base. The fluorine component layer contains fluorine-modified silicone oil or a component derived from a fluorine-containing silane coupling agent.

The mass of the fluorine component layers relative to 100 parts by mass of the bases in the second external additive particles is preferably at least 1 part by mass and no greater than 40 parts by mass, and more preferably at least 5 parts by mass and no greater than 20 parts by mass.

Examples of a fluorine component layer formation method include: a method in which a raw material component of the fluorine component layers is dripped into or sprayed toward a solution including the bases under stirring and heating is performed then; and a method in which the bases are added to a solution of the raw material component of the fluorine component layers under stirring and heating is performed then.

(Bases)

Examples of the bases of the second external additive particles include silica particles, metal oxide particles (e.g., aluminum oxide particles and titanium oxide particles), and resin particles. The second external additive particles are preferably silica particles.

(Fluorine-Containing Silane Coupling Agent)

Examples of the fluorine-containing silane coupling agent include CF₃(CH₂)₂Si(OCH₃)₃, C₄F₉CH₂CH₂Si(OCH₃)₃, C₈F₁₇CH₂CH₂Si(OCH₃)₃, C₇F₁₅COOCH₂CH₂CH₂Si(OCH₃)₃, C₇F₁₅COCH₂CH₂CH₂Si(OCH₃)₃, C₇F₁₅CONHCH₂CH₂CH₂Si(OC₂H₅)₃, C₇F₁₅CONHCH₂CH₂CH₂Si(OCH₃)₃, C₈F₁₇SO₂NHCH₂CH₂CH₂Si(OC₂H₅)₃, C₈F₁₇CH₂CH₂SCH₂CH₂Si(OCH₃)₃, C₁₀F₂₁CH₂CH₂SCH₂CH₂Si(OCH₃)₃, C₈F₁₇CH₂CH₂SiCH₃(OCH₃)₂, C₈F₁₇S₀₂N(CH₂CH₂CH₃)CH₂CH₂CH₂Si(OCH₃)₃, and C₈F₁₇SO₂NHCH₂CH₂N(SO₂C₈F₁₇)CH₂CH₂CH₂Si(OCH₃)₃. The fluorine-containing silane coupling agent is preferably CF₃(CH₂)₂Si(OCH₃)₃.

(Fluorine-Modified Silicone Oil)

An example of the fluorine-modified silicone oil is a silicone oil (e.g., a product of Shin-Etsu Chemical Co., Ltd., “FL-100”) with a fluoroalkyl group.

The fluorine-containing particles have a number average primary particle diameter of preferably at least 50 nm and no greater than 300 nm, and more preferably at least 75 nm and no greater than 150 nm. As a result of the number average primary particle diameter of the fluorine-containing particles being set to at least 50 nm, the fluorine-containing particles can be inhibited from being buried in the toner mother particles. As a result of the number average primary particle diameter of the fluorine-containing particles being set to no greater than 300 nm, the fluorine-containing particles can be inhibited from separating from the toner mother particles.

In terms of causing the fluorine-containing particles to sufficiently exhibit their function while inhibiting separation thereof from the toner mother particles, the amount of the fluorine-containing particles in the toner particles is preferably at least 0.05 parts by mass and no greater than 3.0 parts by mass relative to 100 parts by mass of the toner mother particles, and more preferably at least 0.1 parts by mass and no greater than 1.0 parts by mass.

[Silica Particles]

Silica particles used as the external additive particles are preferably silica particles subjected to surface treatment for imparting positive chargeability. The silica particles have a number average primary particle diameter of preferably at least 10 nm and no greater than 300 nm, and more preferably at least 15 nm and no greater than 80 nm. As a result of the number average primary particle diameter of the silica particles being set to at least 10 nm, the silica particles can be inhibited from being buried in the toner mother particles. As a result of the number average primary particle diameter of the silica particles being set to no greater than 300 nm, the silica particles can be inhibited from separating from the toner mother particles.

In terms of causing the silica particles to sufficiently exhibit their function while inhibiting separation thereof from the toner mother particles, the amount of the silica particles in the toner mother particles is preferably at least 0.1 parts by mass and no greater than 15.0 parts by mass relative to 100 parts by mass of the toner mother particles, and more preferably at least 0.5 parts by mass and no greater than 3.0 parts by mass.

(Additional External Additive Particles)

Examples of the additional external additive particles include particles of metal oxides (e.g., aluminum oxide, magnesium oxide, and zinc oxide), particles of organic acid compounds such as fatty acid metal salts (specific examples include zinc stearate), and resin particles.

[Toner Mother Particles]

No particular limitations are placed on the toner mother particles, and toner mother particles of any known toner can be used. The toner mother particles contain binder resin as a main component, for example. The toner mother particles may further contain an internal additive (e.g., at least one of a colorant, a releasing agent, and a charge control agent) as necessary. Examples of a toner mother particle production method include a pulverization method and an aggregation method, and the pulverization method is preferable.

In terms of formation of favorable images, the toner mother particles preferably have a volume median diameter (D₅₀) of at least 4 μm and no greater than 9 μm.

(Binder Resin)

In terms of providing a toner excellent in low-temperature fixability, the toner mother particles preferably contain a thermoplastic resin as the binder resin, and further preferably contain a thermoplastic resin at a percentage content of at least 85% by mass relative to the total of the binder resin. Examples of the thermoplastic resin include styrene-based resins, acrylic acid ester-based resins, olefin-based resins (specific examples include polyethylene resin and polypropylene resin), vinyl resins (specific examples include vinyl chloride resin, polyvinyl alcohol, vinyl ether resin, and N-vinyl resin), polyester resins, polyamide resins, and urethane resins. Alternatively, a copolymer of any of the above resins, that is, a copolymer (specific examples include styrene-acrylic acid ester-based resin and styrene-butadiene-based resin) of any of the above resins into which any repeating unit has been introduced may be used as the binder resin. The binder resin is preferably a polyester resin.

The percentage content of the binder resin in the toner mother particles is preferably at least 60% by mass and no greater than 95% by mass, and more preferably at least 75% by mass and no greater than 90% by mass.

(Colorant)

The toner mother particles may contain a colorant. The colorant can be a known pigment or dye that matches the color of the toner. The amount of the colorant is preferably at least 1 part by mass and no greater than 20 parts by mass relative to 100 parts by mass of the binder resin in terms of formation of high-quality images using the toner.

The toner mother particles may contain a black colorant. Carbon black can for example be used as a black colorant. Alternatively, a colorant can be used that has been adjusted to a black color using colorants such as a yellow colorant, a magenta colorant, and a cyan colorant.

The toner mother particles may contain a non-black colorant. Examples of the non-black colorant include a yellow colorant, a magenta colorant, and a cyan colorant.

(Releasing Agent)

The toner mother particles may contain a releasing agent. The releasing agent is for example used for the purpose of imparting offset resistance to the toner. In terms of imparting satisfactory offset resistance to the toner, the amount of the releasing agent is preferably at least 1 part by mass and no greater than 20 parts by mass relative to 100 parts by mass of the binder resin.

Examples of the releasing agent include aliphatic hydrocarbon-based waxes, oxides of aliphatic hydrocarbon-based waxes, plant waxes, animal waxes, mineral waxes, ester waxes containing a fatty acid ester as a main component, and waxes in which a part or all of a fatty acid ester has been deoxidized. Examples of the aliphatic hydrocarbon-based waxes include low molecular weight polyethylene, low molecular weight polypropylene, polyolefin copolymers, polyolefin wax, microcrystalline wax, paraffin wax, and Fischer-Tropsch wax. Examples of the oxides of aliphatic hydrocarbon-based waxes include oxidized polyethylene wax and block copolymers of oxidized polyethylene wax. Examples of the plant waxes include candelilla wax, carnauba wax, Japan wax, jojoba wax, and rice wax. Examples of the animal waxes include beeswax, lanolin, and spermaceti. Examples of the mineral waxes include ozokerite, ceresin, and petrolatum. Examples of the ester waxes containing a fatty acid ester as a main component include montanic acid ester wax and castor wax. Examples of the waxes in which a part or all of a fatty acid ester has been deoxidized include deoxidized carnauba wax. The releasing agent is preferably carnauba wax.

In a case in which the toner mother particles contain a releasing agent, a compatibilizer may be added to the toner mother particles in order to improve compatibility between the binder resin and the releasing agent.

(Charge Control Agent)

The toner mother particles may contain a charge control agent. The charge control agent is used for example for the purpose of providing a toner excellent in charge stability or excellent in charge rise characteristic. The charge rise characteristic of a toner is an indicator as to whether the toner can be charged to a specific charge level in a short period of time. The cationic strength of the toner mother particles can be increased through the toner mother particles containing a positively chargeable charge control agent.

Examples of a positively chargeable charge control agent include azine compounds, direct dyes, acid dyes, alkoxylated amine, alkylamide, quaternary ammonium salt, and resin having a quaternary ammonium cationic group. The charge control agent is preferably quaternary ammonium salt or resin having a quaternary ammonium cationic group.

In terms of obtaining a toner excellent in charge stability, the amount of the charge control agent is preferably at least 0.1 parts by mass and no greater than 30 parts by mass relative to 100 parts by mass of the binder resin, and more preferably at least 3 parts by mass and no greater than 10 parts by mass.

[Toner Production Method]

The toner can be produced by a toner production method including toner mother particle preparation and external additive addition.

(Toner Mother Particle Preparation)

In the toner mother particle preparation, toner mother particles are prepared by the aggregation method or the pulverization method, for example.

The aggregation method includes an aggregation process and a coalescence process. In the aggregation process, aggregated particles are formed by aggregating in an aqueous medium fine particles containing a component for forming toner mother particles. In the coalescence process, toner mother particles are formed by causing the components contained in the aggregated particles to coalesce in the aqueous medium.

The following describes the pulverization method. According to the pulverization method, the toner mother particles can be relatively easily prepared and reduction in manufacturing cost can be achieved. In a case in which the toner mother particles are prepared by the pulverization method, the toner mother particle preparation includes a melt kneading process and a pulverization process. The toner mother particle preparation may further include a mixing process before the melt kneading process. The toner mother particle preparation may further include either or both a fine pulverization process and a classification process after the pulverization process.

In the mixing process, the binder resin and an internal additive to be added as necessary are mixed to obtain a mixture. In the melt kneading process, a toner material is melt and kneaded to obtain a melt-knead product. The mixture obtained in the mixing process can be used for example as the toner material. In the pulverization process, the resultant melt-kneaded product is cooled for example to room temperature (25° C.) and pulverized to obtain a pulverized product. In a case in which reduction in diameter of the pulverized product obtained through the pulverization process is necessary, further pulverization process (a fine pulverization process) of the pulverized product may be performed. In order to average the particle diameter of the pulverized product, a process (a classification process) of classifying the resultant pulverized product may be performed. The toner mother particles being the pulverized product are obtained through the processes as described above.

(External Additive Addition)

In the external additive addition, toner particles are obtained by attaching to the surfaces of the toner mother particles an external additive including the first external additive particles and the fluororesin particles. No particular limitations are placed on a method for attaching the external additive to the surfaces of the toner mother particles, and an example of the method is a method in which the toner mother particles and the external additive are stirred using for example a mixer.

### Examples

The following provides more specific description of the present disclosure through use of Examples. However, the present disclosure is not limited to the scope of Examples.

(Number Average Primary Particle Diameter Measurement)

The number average primary particle diameter of external additive particles was measured by the following method. First, using a transmission electron microscope (TEM, product of Hitachi High-Tech Corporation, “H-7100FA”), external additive particles being a measurement target were observed at a magnification of 1,000,000× and a TEM photo of 100 or more of the external additive particles was captured. TEM images of 100 external additive particles were arbitrarily selected from the obtained TEM photo. Equivalent circle diameters of the arbitrarily selected external additive particles were measured in the arbitrarily selected TEM images using image analysis software (product of MITANI CORPORATION, “WinROOF”). A number average value of the measured equivalent circle diameters was calculated. The calculated number average value was taken to be a number average primary particle diameter of the external additive particles.

(Powder Specific Resistance Measurement)

First, 5 g of a measurement target (the first external additive particles) was loaded into a cylindrical measurement cell of an electric resistance meter (product of ADVANTEST CORPORATION, “R6561”). Note that the measurement cell included a metal-made electrode serving as the bottom thereof and a cylinder part made from fluororesin. Subsequently, an electrode (superscript: 2, length: 25.4 mm) of the electric resistance meter was connected to the measurement target loaded in the measurement cell. To the electrode, 1 kg of a load was applied. Subsequently, 10 V of a DC voltage was applied between the electrodes and an electric resistance of the measurement target after 1 minute from the voltage application start was measured. Note that the 1-kg load application was continued from the voltage application start to the measurement end. The measurement was carried out in an environment at a temperature of 25° C. and a relative humidity of 50%. Thereafter, a powder specific resistance (volume resistivity) of the measurement target (specifically, the measurement target loaded in the measurement cell) was calculated based on the value of the measured electric resistance and the dimension of the measurement target at the electric resistance measurement using the following equation.

Powder specific resistance [Ω·cm]=value of electric resistance×sectional area of current path/length of current path

(Measurement of Intensity of Separating Sn)

A glass bottle was charged with 5 g of a measurement target (first external additive particles) and 25 g of ethanol, and hand-shaken until no sediment was left, thereby yielding a mixture. Next, the mixture was subjected to ultrasonication for 1 minute using a desktop ultrasonic disperser (product of SND CO., Ltd., “US-2KS”, output: 100 W, oscillation frequency: 28 kHz). Next, 10 g of ethanol was further added to the mixture and the glass bottle was hand-shaken until no sediment was left. Next, the mixture was subjected to ultrasonication for 5 minutes using an ultrasonic disperser (product of ULTRASONIC ENGINEERING CO., LTD., “MINI WELDER UPW0128A1H”, output: 100 W, oscillation frequency: 28 kHz). Next, the mixture was moved to a centrifuge tube, and subjected to centrifugation at 8000 rpm for 1 minute. Next, a supernatant was collected from the mixture subjected to centrifugation. Next, 1000 μL of the supernatant was added into a trace amount particle container for X-ray measurement (product of Rigaku Corporation, “33990053”, outer diameter: 20 mm), and dried. Fluorescent X-ray analysis was carried out using the trace amount powder container to which the supernatant has been added under the following conditions. Through the above, an intensity of Sn separating into ethanol from the measurement target upon stress application (ultrasonication) to the measurement target was measured.

(Fluorescent X-Ray Analysis)
Analyzer: scanning fluorescent X-ray analyzer (product of Rigaku Corporation, “ZSX”).
X-ray tube (X-ray source): Rh (rhodium)
Excitation conditions: tube voltage of 50 kV and tube current of 50 mA
Measurement range (X-ray irradiation range): diameter of 30 mm
Measured element: Sn

<Toner Preparation>

Toners of Examples 1 to 19 and Comparative Examples 1 to 12 were prepared according to the following methods. In the following description, “pulverizer” refers to a product of Nippon Pneumatic Mfg. Co., Ltd., “JET MILL (registered Japanese trademark) Model 1-2”. A ceramic flat plate was used as an impact plate of the pulverizer. “Stirrer” refers to an apparatus that is a motor (available at AS ONE Corporation, “AS ONE TORNADO MOTOR 1-5472-04”) equipped with a stirring impeller (available at AS ONE Corporation, “AS ONE IMPERLLER Model R-1345”).

[Fluorine-Containing Particle Preparation]

First, fluorine-containing particles (F-1) to (F-6) were prepared. Details of the fluorine-containing particles (F-1) to (F-6) are shown below in Table 1.

(Preparation of Fluorine-Containing Particles (F-1))

As a reaction vessel, an autoclave equipped with a stainless anchor stirrer and a jacket for temperature adjustment was used. The reaction vessel was charged with deionized water (3.5 L), ammonium perfluorooctanoate (5 g), and paraffin wax (product of Nippon Seiro Co., Ltd., “PARAFFIN WAX-115”, 35 g). After the reaction vessel was purged with a nitrogen gas and tetrafluoroethylene (TFE), TFE was further pressed into the reaction vessel. Thereafter, the reaction vessel was heated so that the temperature of the contents of the reaction vessel reached 45° C. while the contents of the reaction vessel were stirred at a stirring speed of 250 rpm. Then, the temperature thereof was kept at 45° C. While an ammonium persulfate aqueous solution (concentration: 1.6% by mass) and a disuccinic acid peroxide aqueous solution (concentration: 2.4% by mass) were pressed into the reaction vessel, supply of TFE was continued so that the internal pressure of the reaction vessel was constant (0.75 MPa). In the manner described above, a polymerization reaction was caused for 60 minutes. After 60 minutes from the polymerization start, the supply of TFE and the stirring of the contents of the reaction vessel were stopped to terminate the polymerization reaction. An ammonium hydroperfluorononate aqueous solution (concentration: 10% by mass, 200 g) was added to a latex-like reaction product obtained through the polymerization reaction. Next, warm water was added to the reaction product to adjust the temperature thereof to 50° C. Next, nitric acid (concentration: 60% by mass, 20 mL) was added to the reaction product while the reaction product was stirred at a stirring speed of 600 rpm. As a result, fluororesin particles began to coagulate from the reaction product. Next, the reaction product was kept being stirred for 1.5 hours (stirring time X) to sufficiently separate the fluororesin particles from the solvent. Next, the solvent was removed from the fluororesin particles, and the resultant fluororesin particles were dried. The resultant fluororesin particles (polytetrafluoroethylene particles, number average primary particle diameter 98 nm) were taken to be fluorine-containing particles (F-1).

(Preparation of Fluorine-Containing Particles (F-2) and (F-3))

Fluorine-containing particles (F-2) and (F-3) were prepared according to the same method as that for preparing the fluorine-containing particles (F-1) in all aspects other than change in the stirring time X to those shown below in Table 1.

(Preparation of Fluorine-Containing Particles (F-4))

Perfluoroalkoxy fluororesin particles (product of Chemours-Mitsui Fluoroproducts Co., Ltd., “PFA-945HP PLUS”) were prepared and taken to be fluorine-containing particles (F-4).

(Preparation of Fluorine-Containing Particles (F-5))

After 100 mL of toluene was added into a reaction vessel, 15 g of a fluorine-containing silane coupling agent (CF₃(CH₂)₂Si(OCH₃)₃) was further added thereinto to dissolve the fluorine-containing silane coupling agent in the toluene. Next, 100 g of silica particles (product of FUSO CHEMICAL CO., LTD., “QUARTRON (registered Japanese trademark) PL-10H”, number average primary particle diameter 90 nm) were further added into the reaction vessel. Next, the contents of the reaction vessel was sufficiently stirred and then heated at 130° C. for 120 minutes. Next, the contents of the reaction vessel were deagglomerated using a pin mill (product of Nara Machinery Co., Ltd., “SAMPLE MILL Model SAM-0”). Through the above, fluorine-containing particles (F-5) (number average primary particle diameter 98 nm) were obtained. The fluorine-containing particles (F-5) each included a silica particle and a fluorine component layer containing a component derived from the fluorine-containing silane coupling agent.

(Preparation of Fluorine-Containing Particles (F-6))

First, 100 g of silica particles (product of FUSO CHEMICAL CO., LTD., “QUARTRON (registered Japanese trademark) PL-10H”, number average primary particle diameter 90 nm) were added into a stainless reaction vessel. After the inside of the reaction vessel was set in a nitrogen atmosphere, 15 g of fluorine-modified silicone oil (product of Shin-Etsu Chemical Co., Ltd., “FL-100”) and 10 mL of n-hexane were sprayed toward the contents of the reaction vessel while the contents of the reaction vessel were stirred at room temperature. After the spraying, the contents of the reaction vessel were further stirred at room temperature for 30 minutes while the nitrogen atmosphere was maintained. Next, the contents of the reaction vessel were stirred at 100° C. for 50 minutes and further stirred at 200° C. for 1.5 hours. Next, the contents of the reaction vessel were allowed to cool to obtain fluorine-containing particles (F-6) (number average primary particle diameter 98 nm). The fluorine-containing particles (F-6) each included a silica particle and a fluorine component layer containing fluorine-modified silicone oil.

TABLE 1

| | Stirring | Particle | |
|---|---|---|---|
| | time X | diameter | |
| | [hour] | [nm] | Composition |
| F-1 | 1.5 | 98 | Polytetrafluoroethylene |
| F-2 | 0.75 | 52 | Polytetrafluoroethylene |
| F-3 | 4.5 | 298 | Polytetrafluoroethylene |
| F-4 | — | 100 | Perfluoroalkoxy fluororesin |
| F-5 | — | 97 | Silica particles (subjected to treatment with |
| | | | fluorine-containing silane coupling agent) |
| F-6 | — | 98 | Silica particles (subjected to treatment with |
| | | | fluorine-modified silicone oil) |

[Preparation of First External Additive Particles]

First external additive particles (A) to (T) were prepared according to the following methods. Treatments for protective layer formation carried out in the preparation were collectively described first. Note that in the following, particles used for treatments for protective layer formation are referred to below as “treatment target particles”.

(Treatment for Forming Protective Layers (TTS))

A mixer (product of KAWATA MFG. CO., LTD., “NANOPERSION PICCOLO”) was loaded with 300 g of the treatment target particles and a titanate coupling agent (product of Ajinomoto Co., Inc., “PLENACT (registered Japanese trademark) TTS”, isopropyltriisostearoyl titanate) in an amount shown below in the column titled “Amount A” in Table 2, and mixing was carried out at 80° C. for 1 hour under a condition of a rotational speed of 6000 rpm. Thereafter, the resultant mixture was dried at 110° C. for 12 hours. Thereafter, the dried mixture was pulverized at a pulverization pressure of 0.6 MPa using the pulverizer. Through the above, treatment target particles covered with protective layers containing a component derived from a titanate coupling agent were obtained.

(Treatment for Forming Protective Layers (MM))

A dispersion was prepared by stirring 1.5 L of ion exchange water and 300 g of the treatment target particles for 30 minutes at the normal temperature using a mixer (product of PRIMIX Corporation, “T.K. HIVIS DISPER MIX Model HM-3D-5”) under a condition of a rotational speed of 30 rpm. Methylol melamine (product of NIPPON CARBIDE INDUSTRIES CO., INC., “NIKARESIN (registered Japanese trademark) S-260”) in an amount shown below in the column titled “Amount A” in Table 2 was added to the resultant dispersion, and stirred at the normal temperature for 5 minutes under a condition of a rotational speed of 30 rpm. After the mixing, the contents of the mixer was moved into a separable flask equipped with a thermometer and a stirring impeller. The temperature of the contents of the separable flask was increased from 35° C. to 70° C. at a rate of 5° C./15 min while the contents of the separable flask was stirred at 200 rpm using a starrier. Next, the contents of the separable flask were stirred at a rotational speed of 90 rpm for 30 minutes while the temperature of the contents of the separable flask was kept at 70° C. Through the above, protective layers were formed on the surfaces of the treatment target particles. Thereafter, the contents of the separable flask were cooled to the normal temperature and filtered using a Buchner funnel. A collected wet cake of the residue was dispersed in an ethanol aqueous solution (ethanol 50% by mass) to prepare a slurry. The resultant slurry was supplied to a continuous surface-modifying apparatus (product of Freund Corporation, “COATMIZER (registered Japanese trademark)”) and dried, thereby obtaining a coarse powder. Conditions for the drying using the continuous surface-modifying apparatus included a hot air temperature of 45° C. and a blow rate of 2 m³/min. The resultant coarse powder was pulverized at a pulverization pressure of 0.6 MPa using the pulverizer. Through the above, treatment target particles covered with protective layers containing methylol melamine resin were obtained.

(Treatment for Forming Protective Layers (sUR))

A dispersion was prepared by stirring 1.5 L of ion exchange water and 300 g of the treatment target particles at the normal temperature for 30 minutes using a mixer (product of PRIMIX Corporation, “T.K. HIVIS DISPER MIX Model HM-3D-5”) under a condition of a rotational speed of 30 rpm. A water-soluble urethane resin (product of DKS Co. Ltd., “SUPERFLEX (registered Japanese trademark) 170”, aqueous solution with a solid concentration of 30% by mass) in an amount shown below in the column titled “Amount A” in Table 2 was added to the resultant dispersion, and stirred for mixing at the normal temperature for 5 minutes under a condition of a rotational speed of 30 rpm. After the mixing, the contents of the mixer were moved into a separable flask equipped with a thermometer and a stirring impeller. The temperature of the contents of the separable flask was increased from 35° C. to 70° C. at a rate of 5° C./15 min while the contents of the separable flask were stirred at 200 rpm using a stirrer. Next, the contents of the separable flask were stirred at a rotational speed of 90 rpm for 30 minutes while the temperature of the contents of the separable flask was kept at 70° C. Thereafter, the contents of the separable flask were cooled to the normal temperature and filtered using a Buchner funnel. A collected wet cake of the residue was dispersed in an ethanol aqueous solution (ethanol 50% by mass) to prepare a slurry. The resultant slurry was supplied to a continuous surface-modifying apparatus (product of Freund Corporation, “COATMIZER (registered Japanese trademark)”) and dried, thereby obtaining a coarse powder. Conditions for the drying using the continuous surface-modifying apparatus included a hot air temperature of 45° C. and a blow rate of 2 m³/min. The resultant coarse powder was pulverized at a pulverization pressure of 0.6 MPa using the pulverizer. Through the above, treatment target particles covered with protective layers containing urethane resin were obtained.

(Treatment for Forming Protective Layers (pAl))

A dispersion was prepared by stirring 1.5 L of ion exchange water and 300 g of the treatment target particles at the normal temperature for 30 minutes using a mixer (product of PRIMIX Corporation, “T.K. HIVIS DISPER MIX Model HM-3D-5”) under a condition of a rotational speed of 30 rpm. The resultant dispersion was heated to 45° C. Thereafter, a polyaluminum chloride aqueous solution (product of Takasugi Pharmaceutical Co., Ltd., concentration: 61.3 g/L) and a 5N sodium hydroxide aqueous solution were simultaneously dripped into the dispersion. The addition amount of the polyaluminum chloride aqueous solution was adjusted so that the amount of the effective component (polyaluminum chloride) reached an amount shown below in the column titled “Amount A” in Table 2. In the dripping, the dispersion was kept at 45° C. and the dripping amount was adjusted so that the pH of the dispersion was kept at 6.0. The dispersion after the dripping was cooled to 30° C. and filtered using a Buchner funnel. A collected wet cake of the residue was dispersed in an ethanol aqueous solution (ethanol 50% by mass) to prepare a slurry. The resultant slurry was supplied to a continuous surface-modifying apparatus (product of Freund Corporation, “COATMIZER (registered Japanese trademark)”) and dried, thereby obtaining a coarse powder. Conditions for the drying using the continuous surface-modifying apparatus included a hot air temperature of 45° C. and a blow rate of 2 m³/min. The resultant coarse powder was pulverized at a pulverization pressure of 0.6 MPa using the pulverizer. Through the above, treatment target particles covered with protective layers containing aluminum hydroxide were obtained.

(Treatment for Forming Protective Layers (iBTMS))

First, 300 g of the treatment target particles, 50 g of an ethanol aqueous solution (ethanol 90% by mass), and a silane coupling agent (product of Tokyo Chemical Industry Co., Ltd., “TRIETHOXY(ISOBUTYL)SILANE”) in an amount shown below in the column titled “Amount A” in Table 2 were mixed. The resultant mixed liquid was loaded into a mixer (product of KAWATA MFG. CO., LTD., “NANOPERSION PICCOLO”), and mixed at 80° C. for 1 hour under a condition of a rotational speed of 6000 rpm. Thereafter, the resultant mixture was dried at 110° C. for 12 hours. Thereafter, the dried mixture was pulverized at a pulverization pressure of 0.6 MPa using the pulverizer. Through the above, treatment target particles covered with protective layers containing a component derived from a silane coupling agent were obtained.

(Treatment for Forming Protective Layers (SiO))

A mixer (product of PRIMIX Corporation, “T.K. HIVIS DISPER MIX Model HM-3D-5”) was loaded with 1.5 L of n-hexane (product of Wako Pure Chemical Industries, Ltd., “WAKO 1st GRADE”) and methylhydrogen silicone oil (product of Shin-Etsu Chemical Co., Ltd., “KF-99”) in an amount shown below in the column titled “Amount A” in Table 2 to dissolve the methylhydrogen silicone oil in the n-hexane. Next, 300 g of the treatment target particles were added to the n-hexane solution in the mixer. Thereafter, the contents of the mixer were stirred at the normal temperature for 30 minutes under a condition of a rotational speed of 30 rpm. After the stirring, the contents of the mixer were moved into a separable flask equipped with a thermometer and a stirring impeller. The temperature of the contents of the separable flask was increased from 35° C. to 70° C. at a rate of 5° C./15 min. while the contents of the separable flask was stirred at 200 rpm using the stirrer impeller. Thereafter, the contents of the separable flask were dried using a reduced pressure dryer (reduced pressure drying) while the temperature of the contents of the separable flask was kept at 70° C. The reduced pressure drying was continued until the contents of the flask were thoroughly dried and the mass of the contents of the flask became unvarying. The contents of the separable flask after the reduced pressure drying were loaded into an electric furnace, and baked at 200° C. for 3 hours in a nitrogen atmosphere. A coarse powder obtained by the baking was pulverized at a pulverization pressure of 0.6 MPa using the pulverizer. Through the above, treatment target particles covered with protective layers containing silicone oil were obtained.

(Preparation of First External Additive Particles (A))

(Preparation of Aluminum Oxide Particles)

A high-speed rotary shear stirrer (product of M TECHNIQUE Co., Ltd., “CLEARMIX (registered Japanese trademark) CLM-2.2S”, maximum length of rotor used 57 mm, minimum diameter 2 mm, clearance 0.3 mm) was set in a pressure vessel, and the pressure vessel with the high-speed rotary shear stirrer was used as a reaction vessel. A mixed liquid A of aluminum isopropoxide and isopropyl alcohol (concentration of aluminum isopropoxide: 60% by mass) and a mixed liquid B of water and isopropyl alcohol (concentration of water: 30% by mass) were prepared. The mixed liquids A and B were continuously charged into the reaction vessel under stirring at 70° C. The amounts of the mixed liquids A and B were adjusted so that the molar ratio (water/aluminum isopropoxide) of the water to the aluminum isopropoxide was 2.5. In the stirring, the speed gradient was set to 100,000/sec. and the dwell time in the stirring zone was set to that indicated below in the column titled “Stirring time B” in Table 2. In the manner described above, a hydrolysis reaction was caused in the contents of the reaction vessel to yield aluminum hydroxide. The resultant aluminum hydroxide was baked at 800° C. for 3 hours to yield aluminum oxide. Thereafter, the resultant aluminum oxide was pulverized at a pulverization pressure of 0.9 MPa using the pulverizer. Through the above, aluminum oxide particles with a number average primary particle diameter of 200 nm were obtained.

(Treatment for Conductive Layer Formation)

Using a mixer (product of PRIMIX Corporation, “HOMOMIXER MARK II Model 2.5”), 300 g of the resultant aluminum oxide particles were dispersed in pure water to prepare 2 L of a suspension. The prepared suspension was heated to 70° C. and kept at 70° C. An acid solution was prepared by dissolving tin(IV) chloride pentahydrate (SnCl₄.5H₂O) in an amount shown below in the column titled “Amount C” in Table 2 and antimony trichloride (SbCl₃) in an amount shown below in the column titled “Amount D” in Table 2 in 750 mL of 2.4N hydrochloric acid prepared separately. The acid solution and a 5N ammonia aqueous solution were dripped in parallel into the prepared suspension over 1.5 hours. In the parallel dripping, the suspension was kept at 70° C. and the dripping amounts of the acid solution and the 5N ammonia aqueous solution were adjusted to keep the pH of the suspension to 7 to 8. Thereafter, filtration was carried out on the suspension. After pure water was added to the resultant residue, filtration was carried out again (washing). The washing was repeated until the electrical conductivity of the filtrate reached no greater than 50 μS/cm. The residue after the washing was dried at 110° C. for 15 hours, and then baked for 2 hours at 700° C. using an electric furnace. The resultant baked product was pulverized at a pulverization pressure of 0.8 MPa using the pulverizer. Through the above, first particles each including an aluminum oxide particle and a conductive layer containing ATO were obtained.

(Treatment for Protective Layer Formation)

Treatment for forming the protective layers (TTS) was carried out on the first particles. This produced first external additive particles (A) (number average primary particle diameter 204 nm) each including an aluminum oxide particle, a conductive layer containing ATO, and a protective layer. The protective layers had a single-layer structure including a layer containing a component derived from a titanate coupling agent.

(Preparation of First External Additive Particles (T))

A mixture of an oxygen gas and titanium tetrachloride obtained by the chlorine method was introduced into a gas-phase oxidation reactor, and caused to react in a gas phase at a temperature of 1000° C. for 3 hours to yield bulky titanium oxide. The bulky titanium oxide was crashed using a hammer mill and the resultant crashed product was washed and dried at 110° C. The dried crashed product was deagglomerated (pressure 1.0 MPa) using a supersonic jet pulverizer (product of Nippon Pneumatic Mfg. Co., Ltd., “JET MILL IDS-2”) to obtain titanium oxide particles (number average primary particle diameter: 204 nm, crystal form: rutile type). Note that the number average primary particle diameter of the titanium oxide particles was adjusted by a setting of the hammer mill.

Treatment for conductive layer formation on the titanium oxide particles was carried out according to the same method as the treatment for conductive layer formation on the first external additive particles (A) in all aspects other than use of 300 g of the titanium oxide particles instead of 300 g of the aluminum oxide particles. In the manner described the above, first particles each including a titanium oxide particle and a conductive layer containing ATO were obtained. Treatment for forming the protective layers (TTS) was carried out next on the first particles. Through the above, first external additive particles (T) each including a titanium oxide particle, a conductive layer containing ATO, and a protective layer were obtained. The protective layers had a single-layer structure including a layer containing a component derived from a titanate coupling agent.

(Preparation of First External Additive Particles (B) to (S))

First external additive particles (B) to (S) were prepared according to the same method as that for preparing the first external additive particles (A) in all aspects other than changes in the stirring time B in preparation of the aluminum oxide particles, the treatment for protective layer formation, and the amount C of the tin(IV) chloride pentahydrate (SnCl₄.5H₂O) and the amount D of the antimony trichloride (SbCl₃) in the treatment for conductive layer formation to those shown below in Table 2.

Note that “Diameter” below in Table 2 indicates a number average primary particle diameter. “Al” and “Ti” in the column titled “Base” indicate aluminum oxide particles and titanium oxide particles, respectively. “TTS”, “iBTMS, “MM”, “sUR”, “pAl”, and “SiO” in the column titled “Protective layer” respectively indicate that the “treatment for forming protective layers (TTS)”, the “treatment for forming protective layers (iBTMS)”, the “treatment for forming protective layers (MM)”, the “treatment for forming protective layers (sUR)”, the treatment for forming the protective layers (pAl)”, and the treatment for forming protectives layer (SiO) described above were carried out.

For example, in Table 2 bellow, the first external additive particles (D) indicate that the treatment for conductive layer formation, the treatment for forming protective layers (TTS), and the treatment for forming protective layers (iBTMS) were carried out on the aluminum oxide particles in the stated order. Also, the first external additive particles (P) indicate that the treatment for forming protective layers (TTS) was carried on the aluminum oxide particles without the treatment for conductive layer formation.

TABLE 2

| First | | | | | Conductive layer | | Protective layer | | | |
|---|---|---|---|---|---|---|---|---|---|---|
| external | | Base | | | Sn | Sb | First layer | | Second layer | |
| additive | Diameter | | Stirring time B | Amount | Amount C | Amount D | | Amount A | | Amount A |
| particles | [nm] | Type | [h] | [g] | [g] | [g] | Type | [g] | Type | [g] |
| A | 204 | Al | 1.0 | 300 | 467 | 82 | TTS | 25 | — | — |
| B | 63 | Al | 0.5 | 300 | 467 | 82 | TTS | 25 | — | — |
| C | 598 | Al | 2.8 | 300 | 467 | 82 | TTS | 25 | — | — |
| D | 205 | Al | 1.0 | 300 | 467 | 82 | TTS | 25 | iBTMS | 26 |
| E | 206 | Al | 1.0 | 300 | 467 | 82 | MM | 25 | iBTMS | 26 |
| F | 206 | Al | 1.0 | 300 | 467 | 82 | sUR | 100 | iBTMS | 26 |
| G | 207 | Al | 1.0 | 300 | 467 | 82 | pAl | 80 | iBTMS | 26 |
| H | 206 | Al | 1.0 | 300 | 467 | 82 | TTS | 25 | SiO | 26 |
| I | 202 | Al | 1.0 | 300 | 349 | 62 | TTS | 25 | — | — |
| J | 211 | Al | 1.0 | 300 | 1560 | 275 | TTS | 25 | — | — |
| K | 204 | Al | 1.0 | 300 | 467 | 82 | iBTMS | 26 | — | — |
| L | 204 | Al | 1.0 | 300 | 467 | 82 | SiO | 21 | — | — |
| M | 56 | Al | 0.4 | 300 | 467 | 82 | TTS | 25 | — | — |
| N | 610 | Al | 3.0 | 300 | 467 | 82 | TTS | 25 | — | — |
| O | 202 | Al | 1.0 | 300 | 336 | 59 | TTS | 25 | — | — |
| P | 204 | Al | 1.0 | 300 | — | — | TTS | 25 | — | — |
| Q | 206 | Al | 1.0 | 300 | 467 | 82 | MM | 25 | — | — |
| R | 206 | Al | 1.0 | 300 | 467 | 82 | sUR | 100 | — | — |
| S | 206 | Al | 1.0 | 300 | 467 | 82 | pAl | 80 | — | — |
| T | 204 | Ti | 1.0 | 300 | 467 | 82 | TTS | 25 | — | — |

[Toner Mother Particle Preparation])

An FM mixer (product of Nippon Coke & Engineering Co., Ltd., “FM-10B”) was used to mix 87.0 parts by mass of polyester resin (product of The Nippon Synthetic Chemical Industry Co., Ltd., “POLYESTER (registered Japanese trademark) HP-313”), 3.0 parts by mass of carbon black (product of Mitsubishi Chemical Corporation, “MA100”), 4.0 parts by mass of carnauba wax (product of TOA KASEI CO., LTD.), 2.0 parts by mass of an azine-based compound (product of ORIENT CHEMICAL INDUSTRIES, Co., Ltd., “BONTRON (registered Japanese trademark) N-71”) as a charge control agent, and 4.0 parts by mass of polymer-type positively chargeable charge control agent (product of FUJIKURA KASEI CO., LTD., “ACRYBASE (registered Japanese trademark) FCA-201-PS”).

The resultant mixture was melt and kneaded using a twin screw extruder (product of former TOSHIBA KIKAI KABUSHIKI KAISHA, “TEM-265S”) to yield a kneaded product. The kneaded product was coarsely pulverized using a pulverizer (product of former TOA KIKAI SEISAKUAHO, “ROTOPLEX (registered Japanese trademark) Model 16/8”) so that the size of the kneaded product reached approximately 2 mm Thus, a coarsely pulverized product was obtained. The coarsely pulverized product was further pulverized using a pulverizer (product of FREUND-TURBO CORPORATION, “TURBO MILL Model RS”) to obtain a finely pulverized product. The finely pulverized product was classified using a classifier (product of Nittetsu Mining Co., Ltd., “ELBOW JET Model EJ-LABO”). As a result, toner mother particles were obtained. The toner mother particles had a D₅₀ of 8.0 μm.

[External Additive Addition]

Using an FM mixer (product of Nippon Coke & Engineering Co., Ltd., “FM-10B”), 100.0 parts by mass of the toner mother particles, 1.5 parts by mass of silica particles (fumed silica particles with surfaces subjected to hydrophobizing treatment, product of Cabot Corporation, “CAB-O-SIL (registered Japanese trademark) TG-308F”), and the external additive particles (specifically any of the fluorine-containing particles (F-1) to (F-6) and any of the first external additive particles (A) to (T)) of any of the types and in any of the amounts shown below in Table 3 were mixed at 3500 μm for 5 minutes. The above mixing attached the external additive(s) to the surfaces of the toner mother particles, thereby obtaining toners of Examples 1 to 19 and Comparative Examples 1 to 12.

With respect to each of the toners of Examples 1 to 19 and Comparative Examples 1 to 12, the intensity of separating Sn and the powder specific resistance of the first external additive particles were measured. The measurement results are shown below in Table 3.

TABLE 3

| | | | | First external additive particles | | | | | | | |
|---|---|---|---|---|---|---|---|---|---|---|---|
| | | | | | | | | | | | Powder |
| | Fluorine-containing particles | | | | | | | Protective layer | | | specific |
| | | Diameter | Amount | | Diameter | Amount | Conductive | First | Second | intensity | resistance |
| | Type | [nm] | [part] | Type | [nm] | [part] | layer | layer | layer | of Sn | [Ω · cm] |
| Example 1 | F-1 | 98 | 0.1 | A | 204 | 1.0 | ATO | TTS | — | 0.59 | 25 |
| Example 2 | F-1 | 98 | 0.5 | A | 204 | 1.0 | ATO | TTS | — | 0.59 | 25 |
| Example 3 | F-1 | 98 | 0.3 | A | 204 | 1.0 | ATO | TTS | — | 0.59 | 25 |
| Example 4 | F-2 | 52 | 0.3 | A | 204 | 1.0 | ATO | TTS | — | 0.59 | 25 |
| Example 5 | F-3 | 298 | 0.3 | A | 204 | 1.0 | ATO | TTS | — | 0.59 | 25 |
| Example 6 | F-1 | 98 | 0.3 | A | 204 | 0.5 | ATO | TTS | — | 0.59 | 25 |
| Example 7 | F-1 | 98 | 0.3 | A | 204 | 1.5 | ATO | TTS | — | 0.59 | 25 |
| Example 8 | F-1 | 98 | 0.3 | B | 63 | 1.0 | ATO | TTS | — | 0.59 | 25 |
| Example 9 | F-1 | 98 | 0.3 | C | 598 | 1.0 | ATO | TTS | — | 0.59 | 25 |
| Example 10 | F-1 | 98 | 0.3 | D | 205 | 1.0 | ATO | TTS | iBTMS | 0.61 | 23 |
| Example 11 | F-1 | 98 | 0.3 | E | 206 | 1.0 | ATO | MM | iBTMS | 0.57 | 24 |
| Example 12 | F-1 | 98 | 0.3 | F | 206 | 1.0 | ATO | sUR | iBTMS | 0.58 | 25 |
| Example 13 | F-1 | 98 | 0.3 | G | 207 | 1.0 | ATO | pAl | iBTMS | 0.59 | 24 |
| Example 14 | F-1 | 98 | 0.3 | H | 206 | 1.0 | ATO | TTS | SiO | 0.59 | 24 |
| Example 15 | F-4 | 100 | 0.3 | A | 204 | 1.0 | ATO | TTS | — | 0.59 | 25 |
| Example 16 | F-5 | 97 | 0.3 | A | 204 | 1.0 | ATO | TTS | — | 0.59 | 25 |
| Example 17 | F-6 | 98 | 0.3 | A | 204 | 1.0 | ATO | TTS | — | 0.59 | 25 |
| Example 18 | F-1 | 98 | 0.3 | I | 202 | 1.0 | ATO | TTS | — | 0.40 | 50 |
| Example 19 | F-1 | 98 | 0.3 | J | 211 | 1.0 | ATO | TTS | — | 1.92 | 1 |
| Comparative | — | — | — | A | 204 | 1.0 | ATO | TTS | — | 0.59 | 25 |
| Example 1 | | | | | | | | | | | |
| Comparative | F-1 | 98 | 0.3 | — | — | — | — | — | — | — | — |
| Example 2 | | | | | | | | | | | |
| Comparative | F-1 | 98 | 0.3 | K | 204 | 1.0 | ATO | iBTMS | — | 2.08 | 25 |
| Example 3 | | | | | | | | | | | |
| Comparative | F-1 | 98 | 0.3 | L | 204 | 1.0 | ATO | SiO | — | 2.11 | 24 |
| Example 4 | | | | | | | | | | | |
| Comparative | F-1 | 98 | 0.3 | M | 56 | 1.0 | ATO | TTS | — | 0.59 | 25 |
| Example 5 | | | | | | | | | | | |
| Comparative | F-1 | 98 | 0.3 | N | 610 | 1.0 | ATO | TTS | — | 0.59 | 25 |
| Example 6 | | | | | | | | | | | |
| Comparative | F-1 | 98 | 0.3 | O | 202 | 1.0 | ATO | TTS | — | 0.38 | 55 |
| Example 7 | | | | | | | | | | | |
| Comparative | F-1 | 98 | 0.3 | P | 204 | 1.0 | — | TTS | — | 0.00 | 2.10 × 10¹⁴ |
| Example 8 | | | | | | | | | | | |
| Comparative | F-1 | 98 | 0.3 | Q | 206 | 1.0 | ATO | MM | — | 0.62 | 26 |
| Example 9 | | | | | | | | | | | |
| Comparative | F-1 | 98 | 0.3 | R | 206 | 1.0 | ATO | sUR | — | 0.63 | 26 |
| Example 10 | | | | | | | | | | | |
| Comparative | F-1 | 98 | 0.3 | S | 206 | 1.0 | ATO | pAl | — | 0.64 | 26 |
| Example 11 | | | | | | | | | | | |
| Comparative | F-1 | 98 | 0.3 | T | 204 | 1.0 | ATO | TTS | — | 0.49 | 24 |
| Example 12 | | | | | | | | | | | |

<Evaluation>

According to the following methods, occurrence or non-occurrence of fogging, charge amount, and filming resistance in a high-temperature and high-humidity environment (HH environment) at a temperature of 32.5° C. and a relative humidity of 80% and charge amount, toner transport amount, image density stability, and toner collectability in a low-temperature and low-humidity environment (LL environment) at a temperature of 10.0° C. and a relative humidity of 10% were evaluated for each of the toners of Examples 1 to 19 and Comparative Examples 1 to 12. The results are shown below in Tables 4 to 6. Note that each evaluation was carried out after the following evaluation apparatus was left to stand for 24 hours in either of the environments (HH environment or LL environment).

[Evaluation Apparatus]

As the evaluation apparatus, an image forming apparatus using a non-magnetic one-component developer (modified version of product of BROTHER INDUSTRIES, LTD., “HL-1040”) was used. An evaluation target (any of the toners of Examples 1 to 19 and Comparative Examples 1 to 12) was loaded into the development device of the evaluation apparatus. A4-size plain paper (product of Mondi, “COLOR COPY (registered Japanese trademark)” was used as a recording medium.

[Fogging in HH Environment]

Using the evaluation apparatus, one pattern image (printing rate 5%) was formed on a sheet of the recording medium in the HH environment. The image density of a blank portion of the sheet of the recording medium with the pattern image formed thereon was measured using a reflectance densitometer (product of X-Rite Inc. “RD918”). Separately, the image density of a non-used sheet of the recording medium was measured. A fogging density (FD) was calculated using the following equation. The calculated fogging density was taken to be an evaluation value for fogging evaluation. Fogging was evaluated according to the following criteria.

FD=(image density of blank portion)−(image density of non-used sheet of recording medium)

(Criteria for Fogging in HH Environment)

A (good): fogging density of no greater than 0.010

B (poor): fogging density of greater than 0.010

[Charge Amount in HH Environment]

The development device of the evaluation apparatus was taken out of the evaluation apparatus after the fogging evaluation in the HH environment. Using a Q/m meter (product of TREK, INC., “MODEL 210HS-1”), toner was sucked from a toner layer in an area of the development sleeve of the development device that corresponded to an area directly before the development nip part and the charge amount [μC/g] of the sucked toner was measured. The charge amount was evaluated according to the following criteria.

(Criteria for Charge Amount in HH Environment)

A (good): charge amount of at least 10 μC/g and no greater than 30 μC/g

B (poor): charge amount of less than 10 μC/g or greater than 30 μC/g

[Filming Resistance in HH Environment]

Using the evaluation apparatus, 2000 pattern images (printing rate 5%) were formed on a sheet of the recording medium in the HH environment. Next, the photosensitive drum was taken out of the evaluation apparatus and the surface of the photosensitive drum was observed using a digital microscope (product of Keyence Corporation, “VHX-6000”). In the observation, the presence or absence of a fixture derived from toner on the surface of the photosensitive drum was checked. Filming resistance was evaluated according to the following criteria.

(Criteria for Filming Resistance in HH Environment)

A (good): no fixtures were observed

B (poor): fixtures were observed

[Charge Amount in LL Environment]

Using the evaluation apparatus, one pattern image (printing rate 5%) was formed on a sheet of the recording medium in the LL environment. Next, the development device was taken out of the evaluation apparatus. Using the aforementioned Q/m meter, toner was sucked from a toner layer in an area of the development sleeve of the development device that corresponded to an area directly before the development nip part and the charge amount [μC/g] of the sucked toner was measured. The measured value was taken to be an initial charge amount.

Next, a pattern image (printing rate 5%) was formed on 2000 sheets of the recording medium using the evaluation apparatus in the LL environment. Using the aforementioned Q/m meter, toner was sucked from a toner layer in an area of the development sleeve of the development device that corresponded to an area directly before the development nip part and the charge amount [μC/g] of the sucked toner was measured. The measured value was taken to be a post-printing charge amount. The initial charge amount and the post-printing charge amount were evaluated according to the following criteria.

(Criteria for Charge Amount in LL Environment)

A (good): charge amount of at least 10 μC/g and no greater than 30 μC/g

B (poor): charge amount of less than 10 μC/g or greater than 30 μC/g

[Toner Transport Amount in LL Environment]

In the measurement of the “initial charge amount in the LL environment” described above, a toner transport amount was calculated from the mass [g] of the sucked toner and the area [m²] of the surface of the development sleeve from which the toner has been sucked by the Q/m meter. In detail, an initial toner transport amount [g/m²] was calculated using an equation “toner transport amount=mass of sucked toner/area of surface of development sleeve from which toner has been sucked”. Similarly, a post-printing toner transport amount was calculated based on the measurement of the “post-printing charge amount in the LL environment” described above. The initial toner transport amount and the post-printing toner transport amount were evaluated according to the following criteria.

(Criteria for Toner Transport Amount in LL Environment)

A (good): toner transport amount of at least 3.5 g/m² and no greater than 7.5 g/m²

B (poor): toner transport amount of less than 3.5 g/m² or greater than 7.5 g/m²

[Image Density Stability in LL Environment]

In the LL environment, a solid image was formed on 2000 sheets of the recording medium using the evaluation apparatus. The image density (initial image density) of the solid image formed on the first sheet and the image density (post-printing image density) of the solid image formed on the 2000^{th} sheet were measured. An absolute value (ΔID) of a difference between the initial image density and the post-printing image density was calculated. The initial image density, the post-printing image density, and the ΔID were evaluated according to the following criteria.

(Criteria for Initial Image Density and Post-Printing Image Density)

A (excellent): image density of at least 1.3 and no greater than 1.5

B (good): image density of at least 1.2 and less than 1.3

C (poor): image density of less than 1.2 or greater than 1.5

(Criteria for ΔID)

A (excellent): ΔID of no greater than 0.1

B (good) ΔID of greater than 0.1 and no greater than 0.2

C (poor): ΔID of greater than 0.2

[Toner Collectability]

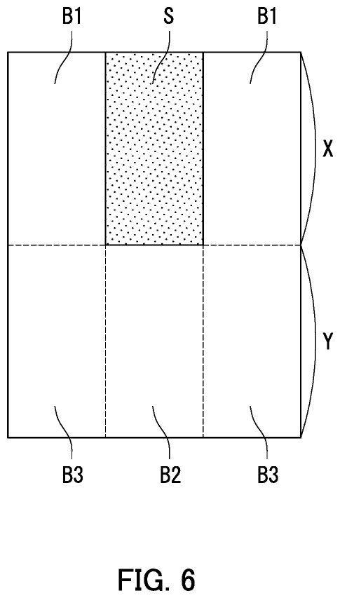

In evaluation of toner collectability, an evaluation image in FIG. 6 described below was formed. The evaluation image in FIG. 6 can be formed through two rotations of the photosensitive drum of the evaluation apparatus. For convenience sake, an area of the evaluation image I formed in the first rotation of the photosensitive drum will be referred to as first area X and an area thereof formed in the second rotation of the photosensitive drum will be referred to as second area Y. The first area X includes a solid image area S located at the central part of the first area X in the width direction thereof and a first non-printed image area B1 located at each end thereof in the width direction thereof. The solid image area S and the first non-printed image areas B1 have an equal width. The second area Y includes a second non-printed image area located at the central part of the second area Y in the width direction thereof and a third non-printed image area B3 located at each end thereof in the width direction thereof. The solid image area S and the second non-printed image area B2 are formed by the same area of the surface of the photosensitive drum. That is, the central area of the photosensitive drum in the width direction thereof forms an image on the first area X in the first rotation of the photosensitive drum and then forms an image on the second non-printed image area B2 in the second rotation of the photosensitive drum. Similarly, the first non-printed image areas B1 and the third non-printed image areas B3 are formed by the respective same areas of the surface of the photosensitive drum. That is, the opposite ends of the photosensitive drum in the width direction thereof form images on the first non-printed image areas B1 in the first rotation of the photosensitive drum and form images on the third non-printed image areas B3 in the second rotation of the photosensitive drum.

In a situation in which the toner transport amount is excessive in an image forming apparatus, fogging may occur resulting from failure in collection of toner developed on the photosensitive drum. In detail, when the toner transport amount is excessive in an image forming apparatus, toner is excessively developed onto an electrostatic latent image on the photosensitive drum. Not all the toner excessively developed on the photosensitive drum may be transferred to a recording medium by the first rotation of the photosensitive drum and a portion of the toner remains on the photosensitive drum as residual toner. When a large amount of such residual toner remains on the photosensitive drum, the residual toner may not be thoroughly collected even by the cleaning member of the image forming apparatus and may be transferred to the recording medium in the second rotation of the photosensitive drum. This causes fogging due to presence of the residual toner.

In evaluation of toner collectability, toner collectability was evaluated based on occurrence or non-occurrence of fogging due to the presence of residual toner. In detail, when fogging due to presence of residual toner occurs, fogging due to presence of residual toner resulting from image formation in the solid image area S occurs in the second non-printed image area B2. In view of the above, the fogging density was measured in the second non-printed image area B2. Specifically, the image density of the second non-printed image area B2 and the image density of a non-used sheet of the recording medium were measured using the aforementioned reflectance densitometer. Thereafter, a fogging density (FD_{A}) of the second non-printed image area B2 was calculated using the following equation (1). Note that a fogging density (FD_{B}) of each third non-printed image area B3 was also measured in order to eliminate influence of fogging caused by something other than presence of residual toner. Specifically, the image density of the third non-printed image area B3 and the image density of a non-used sheet of the recording medium were measured using the aforementioned reflectance densitometer. Next, a fogging density (FD_{B}) of the third non-printed image area B3 was calculated using the following equation (2). Thereafter, influence of fogging caused by something other than presence of residual toner, which is represented by the fogging density (FD_{B}), was eliminated from fogging represented by the fogging density (FD_{A}) of the second non-printed image area B2 using the following equation (3). The calculated value was taken to be an evaluation value for toner collectability.

FD_{A}=(image density of second non-printed image area B2)−(image density of non-used sheet of recording medium) (1)

FD_{B}=(image density of third non-printed image area B3)−(image density of non-used sheet of recording medium) (2)

Evaluation value=FD_{A}−FD_{B} (3)

TABLE 4

| | HH environment | | | | |
|---|---|---|---|---|---|
| | | | Initial charge amount | | |
| | Fogging | | | Evaluation | Filiming |
| | | Evaluation | | value | resistance |
| | Ranking | value | Ranking | [μC/g] | Ranking |
| Example 1 | A | 0.008 | A | 11 | A |
| Example 2 | A | 0.001 | A | 17 | A |
| Example 3 | A | 0.004 | A | 13 | A |
| Example 4 | A | 0.004 | A | 13 | A |
| Example 5 | A | 0.003 | A | 14 | A |
| Example 6 | A | 0.001 | A | 17 | A |
| Example 7 | A | 0.008 | A | 11 | A |
| Example 8 | A | 0.004 | A | 13 | A |
| Example 9 | A | 0.004 | A | 13 | A |
| Example 10 | A | 0.002 | A | 16 | A |
| Example 11 | A | 0.002 | A | 16 | A |
| Example 12 | A | 0.002 | A | 16 | A |
| Example 13 | A | 0.002 | A | 16 | A |
| Example 14 | A | 0.001 | A | 17 | A |
| Example 15 | A | 0.004 | A | 13 | A |
| Example 16 | A | 0.004 | A | 13 | A |
| Example 17 | A | 0.003 | A | 14 | A |
| Example 18 | A | 0.002 | A | 16 | A |
| Example 19 | A | 0.007 | A | 12 | A |
| Comparative | B | 0.021 | B | 3 | A |
| Example 1 | | | | | |
| Comparative | A | 0.000 | A | 18 | C |
| Example 2 | | | | | |
| Comparative | A | 0.002 | A | 16 | A |
| Example 3 | | | | | |
| Comparative | A | 0.002 | A | 16 | A |
| Example 4 | | | | | |
| Comparative | A | 0.004 | A | 13 | B |
| Example 5 | | | | | |
| Comparative | A | 0.004 | A | 13 | A |
| Example 6 | | | | | |
| Comparative | A | 0.001 | A | 17 | A |
| Example 7 | | | | | |
| Comparative | A | 0.000 | A | 18 | A |
| Example 8 | | | | | |
| Comparative | B | 0.014 | B | 7 | A |
| Example 9 | | | | | |
| Comparative | B | 0.013 | B | 8 | A |
| Example 10 | | | | | |
| Comparative | B | 0.014 | B | 6 | A |
| Example 11 | | | | | |
| Comparative | B | 0.015 | B | 6 | A |
| Example 12 | | | | | |

TABLE 5

| | LL environment | | | | | | | |
|---|---|---|---|---|---|---|---|---|
| | Initial charge amount | | Post-printing charge amount | | Initial toner transport amount | | Post-printing toner transport amount | |
| | | Evaluation | | Evaluation | | Evaluation | | Evaluation |
| | Ranking | value [μC/g] | Ranking | value [μC/g] | Ranking | value [g/m²] | Ranking | value [g/m²] |
| Example 1 | A | 20 | A | 23 | A | 5.5 | A | 6.2 |
| Example 2 | A | 25 | A | 30 | A | 6.5 | A | 7.4 |
| Example 3 | A | 22 | A | 25 | A | 6.0 | A | 6.5 |
| Example 4 | A | 22 | A | 24 | A | 6.1 | A | 6.4 |
| Example 5 | A | 21 | A | 24 | A | 5.7 | A | 6.4 |
| Example 6 | A | 23 | A | 29 | A | 6.2 | A | 7.2 |
| Example 7 | A | 19 | A | 21 | A | 5.4 | A | 5.6 |
| Example 8 | A | 22 | A | 25 | A | 6.0 | A | 6.5 |
| Example 9 | A | 21 | A | 24 | A | 5.7 | A | 6.4 |
| Example 10 | A | 23 | A | 26 | A | 6.2 | A | 6.7 |
| Example 11 | A | 22 | A | 26 | A | 6.0 | A | 6.6 |
| Example 12 | A | 22 | A | 26 | A | 6.0 | A | 6.7 |
| Example 13 | A | 23 | A | 27 | A | 6.2 | A | 6.9 |
| Example 14 | A | 23 | A | 26 | A | 6.2 | A | 6.6 |
| Example 15 | A | 22 | A | 25 | A | 6.0 | A | 6.5 |
| Example 16 | A | 22 | A | 26 | A | 5.9 | A | 6.7 |
| Example 17 | A | 22 | A | 25 | A | 6.0 | A | 6.4 |
| Example 18 | A | 24 | A | 29 | A | 6.4 | A | 7.5 |
| Example 19 | A | 19 | A | 22 | A | 5.4 | A | 6.0 |
| Comparative Example 1 | A | 13 | A | 16 | A | 4.2 | B | 1.3 |
| Comparative Example 2 | A | 28 | B | 37 | A | 7.0 | B | 10.4 |
| Comparative Example 3 | A | 22 | B | 31 | A | 6.0 | B | 7.9 |
| Comparative Example 4 | A | 22 | B | 32 | A | 6.0 | B | 8.0 |
| Comparative Example 5 | A | 21 | A | 25 | A | 5.6 | A | 6.5 |
| Comparative Example 6 | A | 21 | A | 25 | A | 5.7 | B | 3.3 |
| Comparative Example 7 | A | 26 | B | 31 | A | 6.7 | B | 7.8 |
| Comparative Example 8 | B | 31 | B | 40 | B | 7.6 | B | 9.3 |
| Comparative Example 9 | A | 22 | A | 24 | A | 6.1 | A | 6.4 |
| Comparative Example 10 | A | 23 | A | 26 | A | 6.2 | A | 6.7 |
| Comparative Example 11 | A | 22 | A | 25 | A | 6.1 | A | 6.6 |
| Comparative Example 12 | A | 21 | A | 24 | A | 5.8 | A | 6.4 |

TABLE 6

| | LL environment | | | | | | |
|---|---|---|---|---|---|---|---|
| | Initial image density | | Post-printing image density | | | Toner collectability | |
| | | Evaluation | | Evaluation | | | Evaluation |
| | Ranking | value | Ranking | value | ΔID | Ranking | value |
| Example 1 | A | 1.31 | A | 1.37 | A | A | 2.2 |
| Example 2 | A | 1.40 | A | 1.50 | A | A | 2.9 |
| Example 3 | A | 1.35 | A | 1.40 | A | A | 2.4 |
| Example 4 | A | 1.36 | A | 1.38 | A | A | 2.3 |
| Example 5 | A | 1.33 | A | 1.38 | A | A | 2.4 |
| Example 6 | A | 1.37 | A | 1.49 | A | A | 2.8 |
| Example 7 | B | 1.29 | A | 1.33 | A | A | 2.0 |
| Example 8 | A | 1.35 | A | 1.40 | A | A | 2.4 |
| Example 9 | A | 1.32 | A | 1.38 | A | A | 2.3 |
| Example 10 | A | 1.37 | A | 1.42 | A | A | 2.5 |
| Example 11 | A | 1.35 | A | 1.41 | A | A | 2.4 |
| Example 12 | A | 1.36 | A | 1.42 | A | A | 2.5 |
| Example 13 | A | 1.37 | A | 1.45 | A | A | 2.6 |
| Example 14 | A | 1.37 | A | 1.43 | A | A | 2.5 |
| Example 15 | A | 1.35 | A | 1.40 | A | A | 2.4 |
| Example 16 | A | 1.36 | A | 1.42 | A | A | 2.5 |
| Example 17 | A | 1.35 | A | 1.37 | A | A | 2.2 |
| Example 18 | A | 1.38 | A | 1.50 | B | A | 2.9 |
| Example 19 | B | 1.29 | A | 1.35 | A | A | 2.1 |
| Comparative Example 1 | B | 1.24 | C | 0.41 | C | A | 0.0 |
| Comparative Example 2 | A | 1.47 | C | 1.79 | C | B | 7.0 |
| Comparative Example 3 | A | 1.33 | C | 1.54 | C | B | 3.4 |
| Comparative Example 4 | A | 1.35 | C | 1.56 | C | B | 3.6 |
| Comparative Example 5 | B | 1.29 | A | 1.40 | B | A | 2.4 |
| Comparative Example 6 | A | 1.33 | C | 1.11 | C | A | 0.7 |
| Comparative Example 7 | A | 1.44 | C | 1.55 | B | B | 3.5 |
| Comparative Example 8 | C | 1.52 | C | 1.73 | C | B | 6.8 |
| Comparative Example 9 | A | 1.34 | A | 1.38 | A | A | 2.3 |
| Comparative Example 10 | A | 1.37 | A | 1.41 | A | A | 2.4 |
| Comparative Example 11 | A | 1.36 | A | 1.41 | A | A | 2.4 |
| Comparative Example 12 | A | 1.33 | A | 1.37 | A | A | 2.2 |

The toners of Examples 1 to 19 each included toner particles. The toner particles each included a toner mother particle and an external additive attached to the surface of the toner mother particle. The external additive included first external additive particles and fluorine-containing particles. The first external additive particles each included an aluminum oxide particle, a conductive layer covering the aluminum oxide particle, and a single-layer or multilayer protective layer covering the conductive layer. The conductive layer contained antimony tin oxide. The protective layer included a layer containing a component derived from a titanate coupling agent, or included an inner layer containing methylol melamine, urethane resin, or aluminum hydroxide and an outer layer containing a component derived from a silane coupling agent. The first external additive particles had a powder specific resistance of no greater than 50 Ω·cm. The first external additive particles had a number average primary particle diameter of at least 60 nm and no greater than 600 nm. As shown in Tables 4 to 6, the toners of Examples 1 to 19 each were excellent in image density stability, charge stability, and filming resistance. Also, occurrence of fogging due to presence of residual toner was inhibited with the use of any of the toners of Examples 1 to 19.

By contrast, the toners of Comparative Examples 1 to 12, each of which did not have the above features, were poor in at least one of image density stability, charge stability, and filming resistance.

In detail, the toner of Comparative Example 1 was poor in image density stability because of no inclusion of fluorine-containing particles.

The toner of Comparative Example 2 was poor in image density stability, charge stability, and filming resistance because of no inclusion of the first external additive particles.

The toners of Comparative Examples 3, 4, and 9 to 11 were poor in charge stability or image density stability because of the first external additive particles thereof not including the specific protective layers.

The toners of Comparative Examples 5 and 6 included the first external additive particles with an excessively small number average primary particle diameter or an excessively large number average primary particle diameter. As a result, the toners of Comparative Examples 5 and 6 were poor in image density stability, charge stability, or filming resistance.

The toner of Comparative Example 7 was poor in charge stability and image density stability because of the first external additive particles thereof having a large powder specific resistance.

The toner of Comparative Example 8 was poor in image density stability and charge stability because of the first external additive particles thereof including no conductive layers.

The toner of Comparative Example 12 was poor in charge stability because of the bases of the first external additive particles thereof being titanium oxide particles rather than aluminum oxide particles.

What is claimed is:

1. A toner comprising toner particles, wherein
the toner particles each include a toner mother particle and an external additive attached to a surface of the toner mother particle,
the external additive includes first external additive particles and fluorine-containing particles,
the first external additive particles each include an aluminum oxide particle, a conductive layer covering the aluminum oxide particle, and a single-layer or multilayer protective layer covering the conductive layer,
the conductive layer contains antimony tin oxide,
the protective layer
includes a layer containing a component derived from a titanate coupling agent, or
includes an inner layer containing methylol melamine, urethane resin, or aluminum hydroxide and an outer layer containing a component derived from a silane coupling agent,
the first external additive particles have a powder specific resistance of no greater than 50 Ω·cm, and
the first external additive particles have a number average primary particle diameter of at least 60 nm and no greater than 600 nm.

2. The toner according to claim 1, wherein
the single-layer or multilayer protective layer has any one of:
a single-layer structure including a layer containing a component derived from a titanate coupling agent;
a two-layer structure including an inner layer containing a component derived from a titanate coupling agent and an outer layer containing silicone oil or a component derived from a silane coupling agent; and
a two-layer structure including an inner layer containing methylol melamine, urethane resin, or aluminum hydroxide and an outer layer containing a component derived from a silane coupling agent.

3. The toner according to claim 1, wherein
the fluorine-containing particles have a number average primary particle diameter of at least 50 nm and no greater than 300 nm.

4. The toner according to claim 1, wherein
the fluorine-containing particles include fluororesin particles or second external additive particles,
the second external additive particles each include a base and a fluorine component layer covering the base,
the fluorine component layer contains fluorine-modified silicone oil or a component derived from a fluorine-containing silane coupling agent.

5. The toner according to claim 4, wherein
the fluororesin particles contain polytetrafluoroethylene or perfluoroalkoxy fluororesin.

6. The toner according to claim 4, wherein
the base is a silica particle.
